(19) United States
(12) Patent Application Publication
(10) Pub. No.: US 2016/0021097 A1
(43) Pub. Date: Jan. 21, 2016

(54) FACILITATING NETWORK AUTHENTICATION

(71) Applicant: Avaya Inc., Basking Ridge, NJ (US)

(72) Inventor: Madhavi SHROTRI, Milpitas, CA (US)

(73) Assignee: Avaya Inc., Basking Ridge, NJ (US)

(21) Appl. No.: 14/335,614

(22) Filed: Jul. 18, 2014

(51) Int. Cl. H04L 29/06

(52) U.S. Cl. CPC H04L 63/0815

(57) ABSTRACT

Embodiments provide single sign on to enterprise applications through a captive portal. Example embodiments include receiving from a captive portal sign-on user interface, a request for network access from a user, the request including authentication credentials, redirecting the user to an identity server when the user has been authenticated for network access using the authentication credentials. Redirecting may include providing the identity server with the authentication credentials, and generating a single sign on (SSO) token using the authentication credentials, the SSO token allowing the user to access enterprise applications.

### BACKGROUND

When a user tries to access a WiFi hot spot (e.g., at a coffee shop, airport, or office) the user receives a pop up login screen or captive portal at their client device that requires the user to enter authentication credentials to sign on to a particular network or to accept terms of use in order to access the Internet. In enterprises, captive portals are sometimes used for providing guests access and employee access for devices that cannot perform 802.1X authentication. When an employee of an enterprise tries to access an employee network through the captive portal, the employee will need to sign in by providing their authentication credentials.

After signing on to the network the user may want to use several enterprise applications. Some networks provide single sign on (SSO) policies that allow users to sign on to a plurality of different enterprise applications using a single sign on system, which acts as an identity provider.

In order to use single sign on across multiple enterprise applications, the user must sign on a second time to request the SSO token, after they have already signed into the network via the captive portal. If authenticated, the user is provided the SSO token. Users are forced to enter two sets of authentication credentials, one to access the network through the captive portal, and another to use single sign on via their SSO token. This process can lead to what is referred to as “password fatigue” where the user tires of entering their authentication credentials for multiple reasons such as network authentication and enterprise application access.

### SUMMARY

According to some embodiments, the present technology may be directed to methods that comprise: (a) receiving from a captive portal sign-on user interface, a request for network access from a user, the request comprising authentication credentials; receiving a captive portal authentication message that indicates that the user has been authenticated for network access using the authentication credentials; (b) redirecting the user to an identity server when the user has been authenticated for network access using the authentication credentials, wherein redirecting comprises providing the identity server with the authentication credentials; (c) generating a single sign (SSO) token by the identity server, the SSO token allowing the user to access enterprise applications and (d) providing the SSO token to the user.

In some embodiments, the user signs on to the enterprise applications using the SSO token without requiring the user to enter authentication credentials when requesting the SSO token or accessing the enterprise applications.

In yet other embodiments, the method includes receiving a request for network access from a user; and causing the captive portal sign-on user interface to be displayed to the user.

According to some embodiments, the method further includes applying one or more user policies that determine which enterprise applications are appropriate for the user.

In one embodiment, the method includes providing the identity server with the authentication credentials comprises automatically filling the authentication credentials into an identity provider login page that is generated by the identity server using a script. According to some embodiments, the present technology is directed to a system comprising: (a) a captive portal configured to: (i) receive from a captive portal sign-on user interface, a request for network access from a user, the request comprising authentication credentials; (ii) authenticate the user for network access; and (iii) redirect the user to an identity server to obtain a single sign on (SSO) token for the user, wherein the redirect includes submitting to the identity server a request for the SSO token, the request comprising SSO authentication credentials; and (b) the identity server being configured to: (1) authenticate the user using the authentication credentials; (2) generate an SSO token for the user, wherein the SSO token allows the user to access enterprise applications; and (3) provide the SSO token to the user.

In one embodiment, the captive portal causes to be displayed a captive portal sign-on user interface to the user for display.

In another embodiment, the system further includes an enterprise server that allows the user to sign on to the enterprise applications without entering authentication credentials when requesting the SSO token or accessing the enterprise applications.

In some embodiments, the captive portal submits the request for the SSO token by generating a script that includes a request for an identity provider login page and the authentication credentials, the script being configured to automatically submit the authentication credentials into the identity provider login page.

In other embodiments, the captive portal receives a request for network access from a user; and returns the captive portal sign-on user interface to the user.

In another embodiment, the server applies one or more user policies to specify how the user can access the one or more enterprise applications.

According to other embodiments, the present technology is directed to a method that comprises, in response to authenticating a user for network access through a captive portal interface, automatically generating a single sign on (SSO) token that allows the user to access the enterprise applications; and providing the SSO token to the user.

In another embodiment, the SSO login object is an SSO token that is provided to a web browser of a client of the user, the SSO token being a cookie.

In yet another embodiment, the user signs on to the enterprise applications using the SSO login object without entering authentication credentials when requesting the SSO login object or accessing the enterprise applications.

In one embodiment, the method also includes receiving a request for network access from a user and returning a captive portal sign-on user interface to the user.

In some embodiments, the SSO login object comprises any of an SSO token or a secure certificate.

In another embodiment, generating the SSO login object comprises: (1) receiving SSO authentication credentials in a captive portal authentication message; and (2) providing the SSO authentication credentials to an identity provider login page without requiring the user to enter the SSO authentication credentials into the identity provider login page.

In one embodiment, generating the SSO login object comprises receiving authentication credentials during network authentication and providing the authentication credentials to an identity provider login page without requiring the user to re-enter the authentication credentials into the identity provider login page.

In some embodiments, providing the authentication credentials includes generating a script that requests the identity provider login page and automatically submits the authentication credentials to the identity provider login page.

In one embodiment, the method further includes locating user policies for each of the one or more enterprise applications and applying the user policies when the SSO token is provided to a service provider of the one or more enterprise applications, wherein the user policies specify how the user can access or utilize the one or more enterprise applications.

In yet other embodiments, the service provider redirects a request for the one or more enterprise applications to an identity server that locates and applies the user policies.

### BRIEF DESCRIPTION OF THE DRAWINGS

Certain embodiments of the present technology are illustrated by the accompanying figures. It will be understood that the figures are not necessarily to scale and that details not necessary for an understanding of the technology or that render other details difficult to perceive may be omitted. It will be understood that the technology is not necessarily limited to the particular embodiments illustrated herein.

FIG. 1 is a schematic diagram of an example system for providing captive portal login and single sign on (SSO) for enterprise applications, in accordance with at least one embodiment;

FIG. 2 is a signal flow diagram of an example process for captive portal and SSO login using an SSO key in accordance with at least one embodiment;

FIG. 3 is an example simplified flow diagram for facilitating network authentication, according to some embodiments; and

FIG. 4 is an example simplified flow diagram for facilitating network authentication, according to some embodiments; and

FIG. 5 illustrates an example computer system that may be used to implement embodiments according to the present technology.

### DETAILED DESCRIPTION

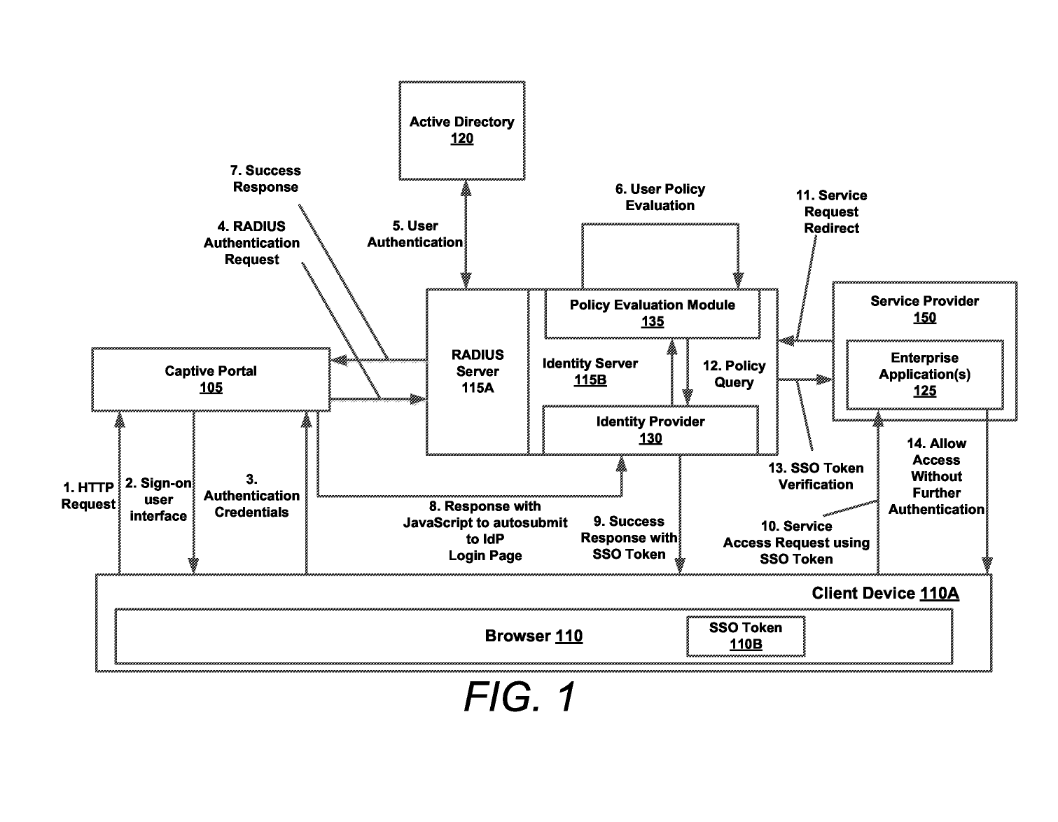

FIG. 1 is a schematic diagram of an example system architecture 100 that includes a captive portal 105, a browser 110, a RADIUS server 115A, an identity server 115B, an active directory 120, and one or more enterprise applications 125. In various embodiments the captive portal 105, RADIUS server 115A, identity server 115B, active directory 120, or combinations of these systems may be combined into a single server or device.

In some embodiments, the captive portal 105 is provided by a server that causes a captive portal sign-on user interface to be displayed in a browser on a client device 110A of a user. For example, when a user attempts to access a network connection to the Internet at an access point at various locations such as a cafe, library, or hotel, the user opens their browser 110 on their client device 110A (e.g., a Smartphone). The browser 110 attempts to access a network resource, such as a webpage, and is redirected to a captive portal sign-on user interface by the captive portal 105, instead.

In various embodiments, the captive portal sign-on user interface may include input interfaces that allow a user to input a username and/or password, referred to herein as “authentication credentials”. In some embodiments, the authentication credentials are transmitted to a RADIUS server 115A. The RADIUS server 115A authenticates the user, allowing the client device 110A to access the network. User network authentication is the end point for a captive portal sign on process. That is, a captive portal process is complete when a user is granted access to the network.

In some embodiments, once the user is authenticated at the captive portal 105, without any further interaction or input from the user, a single sign on (SSO) process is executed by the captive portal 105 and the identity server 115B. When the user is authenticated at the captive portal 105 for network access, the captive portal 105 will execute a redirect for the user to the identity server 115B using, for example, a script. The script is configured to perform an automatic SSO token request process. In one embodiment, the script requests an identity provider login page, such as a web page that requests authentication credentials. This identity provider login page is similar to the captive portal sign-on user interface inasmuch as it requires the user's authentication credentials prior to authenticating the user and providing them with an SSO token. In various embodiments, a SSO token allows for authentication of the user for one or more enterprise applications (e.g., corporate accounting, corporate intranet, product inventory, email, corporate database, corporate HR interface, corporate contacts directory, corporate communication interface, etc.).

Identity server 115B generates the SSO token after the identity server 115B verifies the authenticity of the user. The SSO token will allow access to enterprise applications.

Once the identity server 115B authenticates the user using the authentication credentials supplied by the script (through the identity provider login page), the identity server 115B generates a SSO login object, such as the SSO token. An SSO token 110B is provided back to the client device 110A. In one embodiment the SSO token 110B is stored in the browser 110 as a cookie or other type of persistent data. The client device 110A can utilize this SSO token to access the enterprise application(s) 125. That is, the user can access a plurality of web applications with the SSO token 110B that is automatically generated when the user is authenticated at the captive portal.

The enterprise application(s) 125 are facilitated by a service provider, such as service provider 150 that manages or controls one or more of the enterprise applications 125. A service provider is an enterprise or company that provides, manages, or controls one or more enterprise applications 125. In one embodiment, a service provider can include an application service provider that provides a web-based application, or software-as-a-service (SaaS), to customers. In one example, an application service provider offers a web-based accounting enterprise application that enterprise users access using their SSO token. Other examples of application service provider offerings include business operations, program management, customer relations, inventory, and so forth.

The service provider 150 managing the enterprise application sends/redirects the request to access the enterprise application to the identity provider 130 of the identity server 115B. This request includes the SSO token. The identity provider 130 knows that the user is authenticated because the user has presented a valid SSO token. That is, the identity provider 130 is the entity that generates the SSO token. When the identity provider 130 receives the SSO token from the service provider 150, the identity provider 130 can determine that the user has already been authenticated by the identity server 115B by validating the SSO token.

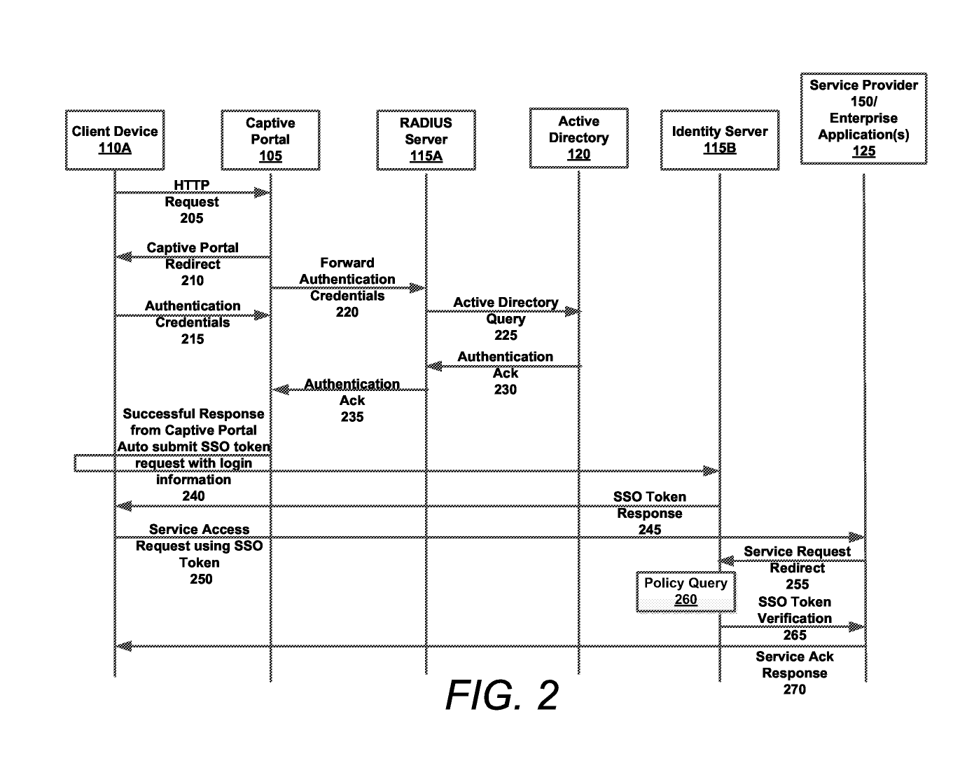

If the SSO token is valid, the identity server 115B can then perform a policy evaluation to determine if the user is allowed access to the requested enterprise application or not. This response is transmitted to the service provider 150 as an acknowledgement or failure. Additional details regarding the captive portal login and automatic SSO token request process are set forth below with reference to the description of FIG. 2.

In some instances any one or combination of, the RADIUS server 115A, active directory 120, identity server 115B and/or enterprise application(s) 125 can be implemented as a cloud computing system. In an example embodiment, a cloud-based computing environment is a resource that combines the computational power of a large grouping of processors and/or that combines the storage capacity of a large grouping of computer memories or storage devices. For example, systems that provide a cloud resource may be utilized exclusively by their owners; or such systems may be accessible to outside users who deploy applications within the computing infrastructure to obtain the benefit of large computational or storage resources.

The cloud may be formed, for example, by a network of web servers, with each web server (or at least a plurality thereof) providing processor and/or storage resources. These servers may manage workloads provided by multiple users (e.g., cloud resource consumers or other users). In various embodiments, each user places workload demands upon the cloud that vary in real-time, sometimes dramatically. The nature and extent of these variations depend on the type of business associated with the user.

The client device 110A may communicatively couple with the captive portal 105 and enterprise application(s) 125 over any one or combination of a number of public and/or private networks. Suitable networks may include or interface with any one or more of, for instance, a local intranet, a PAN (Personal Area Network), a LAN (Local Area Network), a WAN (Wide Area Network), a MAN (Metropolitan Area Network), a virtual private network (VPN), a storage area network (SAN), a frame relay connection, an Advanced Intelligent Network (AIN) connection, a synchronous optical network (SONET) connection, a digital T1, T3, E1 or E3 line, Digital Data Service (DDS) connection, DSL (Digital Subscriber Line) connection, an Ethernet connection, an ISDN (Integrated Services Digital Network) line, a dial-up port such as a V.90, V.34 or V.34bis analog modem connection, a cable modem, an ATM (Asynchronous Transfer Mode) connection, or an FDDI (Fiber Distributed Data Interface) or CDDI (Copper Distributed Data Interface) connection.

Furthermore, communications may also include links to any of a variety of wireless networks, including WAP (Wireless Application Protocol), GPRS (General Packet Radio Service), GSM (Global System for Mobile Communication), CDMA (Code Division Multiple Access) or TDMA (Time Division Multiple Access), 3G, 4GLTE and other cellular phone networks, GPS (Global Positioning System), CDPD (cellular digital packet data), RIM (Research in Motion, Limited) duplex paging network, Bluetooth radio, or an IEEE 802.11-based radio frequency network. The network can further include or interface with any one or more of an RS-232 serial connection, an IEEE-1394 (Firewire) connection, a Fiber Channel connection, an IrDA (infrared) port, a SCSI (Small Computer Systems Interface) connection, a USB (Universal Serial Bus) connection or other wired or wireless, digital or analog interface or connection, mesh or Digi® networking.

FIG. 2 is a signal flow diagram showing an example method for captive portal sign on and automatic SSO token generation. The user provides authentication credentials at a captive portal. Using the authentication credentials, the RADIUS server 115A authenticates the user by performing a lookup of the user against an active directory 120 that stores user information, such as corresponding authentication credentials. In various implementations, when the user requests access to an enterprise application which are protected by service providers such as service provider 150, the service providers may not actually be abe to interpret the SSO token directly, so the service provider 150 redirects the request from the user, which includes the SSO token, to the identity provider 130 for authentication. When the request is received by the identity provider 130 again, the SSO token is present, so the identity provider 130 authenticates the user and redirects the user (and specifically the client device 110A) back to the service provider 150. The service provider 150 interprets and verifies this authentication and allows the user access to the enterprise application. In FIG. 2 the service provider 150 is illustrated in combination with the enterprise application(s) 125.

The authentication and verification processes all occur without user having to do anything additional (e.g., take additional or extra steps); so to the user it appears that possession of SSO token has given the user access to the enterprise application(s) 125.

In an example use case, the client device 110A transmits to the captive portal 105 an HTTP request 205 for network access. The client device 110A transmits this HTTP request by connecting with an access point that provides network access. When the browser 110 of the client device 110A attempts to navigate to a location on the network, the captive portal 105 redirects the request 210 to and causes to be displayed a captive portal sign-on user interface that requests authentication credentials from the user (e.g., “Please enter your username and password”). Once the user fulfills the request for authentication credentials 215, the captive portal 105 forwards the request 220 to the RADIUS server 115A for authentication. The RADIUS server 115A performs an active directory query 225 or lookup of the user, using the authentication credentials. The active directory 120 responds with an authentication Ack (Acknowledgement) 230 that indicates that the user has been authenticated using their authentication credentials.

The active directory 120 may store authentication credentials for a given user. In some embodiments, the active directory 120 is a special purpose database and directory service that automates network management of user data, security, and distributed resources, and enables interoperation with other directories. The active directory 120 can be used to store objects and their attributes, such as user records and their associated authentication credentials and user policies.

For example, the user may need to access three different enterprise applications such as accounting, human resources, and inventory applications. The user may maintain unique authentication credentials for each of these three different enterprise applications. These unique sets of authentication credentials for each enterprise application can be stored in the active directory 120 for the user.

In an example embodiment, if the user is authenticated, the RADIUS server 115A returns to the captive portal 105 an acknowledgement message 235 that the user has been successfully authenticated. The captive portal 105 then establishes a network connection for the client device 110A. In one example, the captive portal 105 may redirect the browser of the client device 110A to a landing page. The user can navigate from this landing page as desired.

If the user is not authenticated, the RADIUS server 115A will respond with an authentication failure message. The captive portal 105 can prompt the user to input their authentication credentials again.

In various embodiments, after the user is authenticated by the RADIUS server 115A, the captive portal 105 performs a redirect 240 which automatically transmits to the identity engine 115B a request to generate a SSO token. The identity provider 130 automatically receives the request for the SSO token when the user is authenticated at the captive portal 105 such that the user does not have to perform a second logon process, such as entering authentication credentials with the identity provider 130 in order to obtain an SSO token.

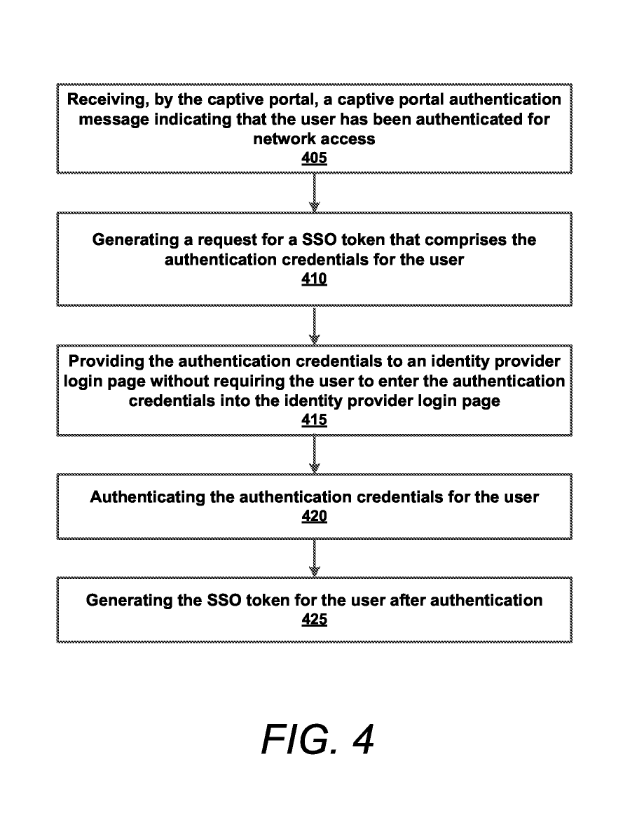

For example, the captive portal 105 may automatically submit to the identity provider 130 a JavaScript to an identity provider login page. An example method for requesting an SSO token by a captive portal 105 is described in greater detail below with reference to FIG. 4.

An example script that can be used for automatic SSO token request after captive portal authentication. Assume a login page generated by the identity provider 130 includes:

<form id=“loginForm” name=“loginForm”
action=“/idp/Authn/IdeUserPassword” method=“post”>

<table>

<tr> <td width=“20%”><label

for=“username”>Username:</label></td><td><input name=“j_username”
type=“text” id=“username” autocapitalize=“off” /></td></tr>
<tr><td><label for=“password”>Password:</label></td><td><input
name=“j_password” type=“password” id=“password” /></td></tr>
<tr><td></td><td><button type=“submit” value=“Login”
>Continue</button></td></tr>

</table>

</form>

Also, assume that the identity server 115B is running on a host such as ide.domain.com. The captive portal 105 can send a response which will programmatically generate a post of that form action URL by combining the two parts as follows: https://ide.domain.com/idp/Authn/IdeUserPassword

<!DOCTYPE HTML PUBLIC “-//W3C//DTD HTML 4.01

Transitional//EN” “http://www.w3.org/TR/html4/loose.dtd”><html>

<head>

<title>Success </title><meta http-equiv=“Content-Type”

content=“text/html; charset=iso-8859-1”>

<script type=“text/javascript” language=“javascript”>
function submitform( ){

document.getElementById(‘loginForm’).submit( );

}

</script>

</head>
<body onload=“submitform( )”><form name=“loginForm”
id=“name=“loginForm”
“action=“https://ide.domian.com/idp/Authn/IdeUserPassword”
method=“post” >
<input type=‘hidden’ name=‘j_username’ value=%%substitute here user’s
name%%>
<input type=‘hidden’ name=‘j_password’ value=%%substitute here
user’s password%%>

</form>

</body>

</html>

The repetitive input of authentication credentials can lead to what is referred to as password fatigue, where the user tires of being asked to repeatedly log into various applications. The present technology reduces or eliminates this password fatigue by automatically providing the authentication credentials to the identity provider 130 using, for example, the above script or other similar means, after authentication of the user by the captive portal 105. If the identity server authenticates the user based on the authentication credentials included in the redirect request 240, the identity provider 130 will transmit an SSO token response 245 to the client device 110A that includes the SSO token.

In some instances, the identity provider 130 can also evaluate other information about the user in order to authenticate the user for an SSO token. These other types of information may include, but are not limited to, a time that authentication took place, an internet protocol (IP) address through which the user authenticated, an authentication mechanism used to authenticate the user, and so forth.

The user can use the SSO token to access each of the enterprise applications individually. In one example the SSO token is stored in the browser of the user's client device 110A. When the user attempts to access an enterprise application using their browser, the browser provides the SSO token to the service provider 150 of the enterprise application 125 in a service access request message 250. The service provider 150 validates the SSO token by transmitting a service request redirect message 255 to the identity provider 130. As mentioned above, the SSO token is the handle used by the identity provider 130 to locate and authenticate the authentication credentials of the user requesting access to the enterprise application. This redirection to the identity provider 130 occurs transparently to the user.

In addition to verifying authentication credentials, the identity server 115B may also store and apply user policies that are specific to the user. The user policies affect how the user can access or utilize the enterprise applications.

By way of example, the identity server 115B may query 260 a policy evaluation module 135 for user polices if applicable. If one or more user policies are required for the user, a policy evaluation is performed by the policy evaluation module 135. A user policy, for example, may include constraints that are placed on a user for an enterprise application. Examples of user policy application are provided below.

After authenticating the user by evaluating their SSO token and applying any user policies, the identity provider 130 will transmit an SSO token verification message 265 back to the service provider 150. The client device 110A will then be granted access to the enterprise application 125 after receiving a service Ack response 270 from the service provider 150.

The following paragraphs provide further description regarding the application of user policies, as well as example use cases that explain how tokens are used by an end user. In one example, a user policy may specify that the user can only view or print data generated by the enterprise application. Another example of a user policy may specify that the user can not only view and print data, but also edit or delete data. In one non-limiting example, an enterprise application for accounting is accessible to two different users. The user policy for one of these users includes a user policy that only allows the user to view sensitive tax related documents. The second user has a user policy that allows the second user to edit or modify these sensitive tax related documents.

In another example scenario a user may be an executive level employee such as a chief financial officer, the user may be provisioned with access to enterprise accounting applications, enterprise financial applications, and enterprise project management applications. In some embodiments, one or more user policies that are applied by the identity server 115B may dictate that the executive level employee has higher level access to the applications as compared with other employees that may access the same services.

When the executive level employee logs into the captive portal using their authentication credentials, a SSO token is automatically requested and generated.

When the executive level employee presents their SSO token to a service provider 150 for access to an enterprise application in a service access request message, the service provider 150 redirects the request to the identity provider 130. The SSO token is “presented” by the browser 110 of the client device 110A when the browser 110 access an enterprise application.

The identity provider 130 authenticates the executive level employee due to the presence of the SSO token. The identity server 115B then queries the policy evaluation module 135 to determine if any user policies need to be applied to the executive level employee. If so, the identity server 115B applies the user policies and transmits an authentication success message back to the service provider 150.

In essence, the service provider 150 depends upon the identity server 115B to authenticate the user, rather than requiring the service provider to verify or authenticate the user.

The executive level employee can then access and utilize the enterprise application in accordance with the user policies that were provided to the service provider 150 by the identity server 115B.

If authenticated by the identity server 115B, the service provider 150 associated with the enterprise application(s) 125 will transmit to the client device 110A a service Ack response 260 giving the client device 110A access to the requested service. In various embodiments, the number and type of enterprise applications that can be accessed by the user are defined by user policies of the user that are maintained by the identity server 115B.

In some embodiments, because the SSO token is immediately generated during captive portal authentication, and captive portal authentication occurs without Layer 2 (L2) level or 802.1X authentication of the user, the generation of the SSO token by the system occurs without Layer 2 (L2) level or 802.1X authentication of the user. Again, it is also advantageous that the user is able to sign on to the enterprise applications using the SSO token without requiring to enter authentication credentials when requesting the SSO token or accessing the enterprise applications.

In various embodiments, the system may utilize any suitable SSO login object other than a SSO token. Examples of other suitable SSO login objects include a secure certificate, Other SSO login objects that would be known to one of ordinary skill in the art can also be likewise utilized in accordance with the present technology.

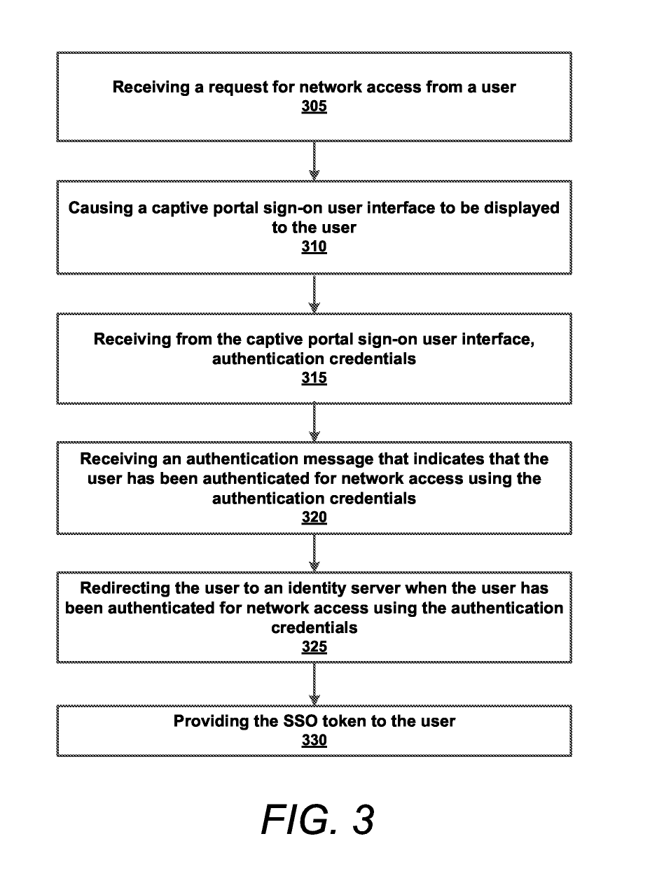

FIG. 3 is an example simplified flow diagram for facilitating network authentication, according to some embodiments. The illustrated example method includes the creation of a SSO token 110B in response to authentication of a user for network access at a captive portal. In one embodiment, the method includes receiving 305 a request for network access from the user. For example, the user connects to a network access point in a hotel or coffee shop. When the user opens their browser on their client device 110A, the user is redirected to a captive portal sign-on user interface. Thus, the method may include causing 310 the captive portal sign-on user interface to be displayed to the user.

The method includes receiving 315 from a captive portal sign-on user interface, authentication credentials such as a username and password. Once the user submits their authentication credentials, the captive portal 105 forwards the request to a RADIUS server for authentication. The authentication credentials may include authentication credentials for network access, and these authentication credentials are the same as those used to request a SSO token from the identity server 115B. The authentication credentials correspond to a user identity that is stored in the active directory 120. That is, the identity server 115B is consulted to authenticate the user for both network access and SSO token generation using the same authentication credentials that correspond to the user identity.

The method also includes receiving 320 an authentication message that indicates that the user has been authenticated for network access using the authentication credentials. For example, the captive portal 105 may receive this authentication message from the RADIUS server 115A.

If the user is authenticated by the RADIUS server 115A, the method includes the captive portal 105 redirecting 325 the user to the identity server 115B when the user has been authenticated for network access using the authentication credentials. It will be understood that redirecting includes providing the identity server with the authentication credentials. In some embodiments, this redirection occurs automatically and transparently to the user. For example, the captive portal 105 may receive a captive portal authentication message from the RADIUS server 115A. Next, the method includes the captive portal 105 requesting 325 a single sign on (SSO) token for the user in response to the authentication message. A detailed example of the captive portal 105 requesting a SSO token is provided in FIG. 4.

Again, the SSO token can be used by the user to access enterprise applications. In one example, the captive portal provides the request for the SSO token to an identity server 115B. The identity server 115B generates the SSO token. The method also includes the identity server 115B providing 330 the SSO token to the user.

FIG. 4 is an example simplified flow diagram for facilitating network authentication, according to some embodiments. The illustrated method includes an example embodiment for requesting a SSO token in response to successful network authentication at a captive portal. In one embodiment, the method includes the captive portal 105 receiving 405 a captive portal authentication message indicating that the user has been authenticated for network access. The captive portal authentication message indicates that the user has been successfully authenticated using the authentication credentials provided by the user at the captive portal sign-on user interface.

Next, the method may include the captive portal 105 generating 410 a request for a SSO token that includes the authentication credentials for the user.

The method includes the captive portal 105 providing 415 the authentication credentials to an identity provider login page without requiring the user to enter their authentication credentials into the identity provider login page. For example, the authentication credentials can be automatically submitted to an identity provider login page generated by the identity server 115B. In one example, the script automatically fills the authentication credentials into the identity provider login page that is generated by the identity server 115B.

In one example, the captive portal 105 generates a JavaScript that includes the SSO authentication credentials. The JavaScript requests the identity provider login page and performs a logon process. For example, the captive portal 105 attempts to log onto the identity server 115B to request the SSO token. In response, the identity server 115B would respond to the captive portal 105 with an identity provider (IdP login page) login page. The captive portal 105 can automatically submit the user's authentication credentials to the identity provider login page.

In some embodiments the method includes the identity server 115B authenticating 420 the authentication credentials for the user and generating 425 the SSO token for the user. The SSO token is then provided to the client device 110A of the user.

Embodiments described herein provide various advantages. For example, to obtain a SSO token, the user would encounter a login page UI that is generated by an identity engine/server. The user would supply their authentication credentials and the identity engine/server would authenticate the user and automatically generate and send them a SSO token. The automatic request to generate the SSO token as described in the example embodiments above is in sharp contrast to an approach where a user would use two disjointed authentication processes, one for logging onto the captive portal to gain network access, and a second, distinct process for requesting authentication credentials in order to gain access to multiple enterprise applications.

In addition to enhancing the user experience by speeding up login processes for enterprise applications, the present technology enhances network security because the user is only required to maintain one set of authentication credentials, which are the authentication credentials required to log into the captive portal for network access. In various embodiments, the authentication credentials necessary to obtain a SSO token for accessing the enterprise applications may be stored transparently to the user. For example, the authentication credentials in some instances are stored in the active directory and are accessed only when a successful authentication of the user occurs at the captive portal.

Another example of an advantage provided by the present embodiments is that the SSO token is immediately generated during captive portal authentication, and captive portal authentication may occur without Layer 2 (L2) level or 802.1X authentication of the user. Accordingly, the generation of the SSO token by the system occurs without Layer 2 (L2) level or 802.1X authentication of the user.

The term “client device” as used throughout should be construed broadly to include any computing device that can be used to access a captive portal and/or utilize a SSO token. A client device may include an end user computer system, a Smartphone, a telephone, tablet, PDA, mobile internet device, wearable device, etc. In some embodiments a client device may include any suitable device or system that allows a customer to access a network connection.

An SSO token is a handle which points to a data structure where the identity provider system stores information about a user such as a username, password, and/or user policies that define how a user can access or utilize a particular enterprise application. The SSO token identifies the user and is unique for the user.

In various embodiments, a SSO token is a handle that references a user's identity on the identity server 115B. The user's identity may include descriptive information regarding the user (with the user's consent), such as the user's name, a location, authentication credentials or other descriptive information. After the SSO token expires the user is required to obtain a new SSO token. For example, the user can again log in through the captive portal to obtain a new SSO token.

A captive portal or other (UI) as described herein may include any graphical user interface that allows a user to input authentication credentials. For example, the UI may include text input boxes for receiving a username or password. The UI may include other selectable input objects such as radio buttons, checkboxes, sliders, to allow the user to select login features. An example of a login feature includes username and/or password persistence, where the username and/or the password of the user are automatically inserted into text input boxes when the browser loads the captive portal UI. Another login feature includes a username and/or password retrieval or reset checkbox or hyperlink that allows the user to request their username or password in the event that either are lost. When the user selects the retrieval option, the system redirects the user to a UI for requesting their username or password. For example, if the user has lost their password the system may ask the user for their username and/or email address or other identifying information. The system can email the lost password to the user at the received email address.

In the following description, for purposes of explanation, numerous specific details are set forth in order to provide a thorough understanding of the disclosure. It will be apparent, however, to one skilled in the art, that the disclosure may be practiced without these specific details. In other instances, structures and devices are shown at block diagram form only in order to avoid obscuring the disclosure.

Reference throughout this specification to “one embodiment” or “an embodiment” means that a particular feature, structure, or characteristic described in connection with the embodiment is included in at least one embodiment of the present invention. Thus, the appearances of the phrases “in one embodiment” or “in an embodiment” or “according to one embodiment” (or other phrases having similar import) at various places throughout this specification are not necessarily all referring to the same embodiment. Furthermore, the particular features, structures, or characteristics may be combined in any suitable manner in one or more embodiments. Furthermore, depending on the context of discussion herein, a singular term may include its plural forms and a plural term may include its singular form. Similarly, a hyphenated term (e.g., “on-demand”) may be occasionally and interchangeably used with its non-hyphenated version (e.g., “on demand”), a capitalized entry (e.g., “Software”) may be interchangeably used with its non-capitalized version (e.g., “software”), a plural term may be indicated with or without an apostrophe (e.g., PE's or PEs), and an italicized term (e.g., “N+1”) may be interchangeably used with its non-italicized version (e.g., “N+1”). Such occasional interchangeable uses shall not be considered inconsistent with each other.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

It is noted at the outset that the terms “coupled,” “connected,” “connecting,” “electrically connected,” etc., are used interchangeably herein to generally refer to the condition of being electrically/electronically connected. Similarly, a first entity is considered to be in “communication” with a second entity (or entities) when the first entity electrically sends and/or receives (whether through wireline or wireless means) information signals (whether containing data information or non-data/control information) to the second entity regardless of the type (analog or digital) of those signals. It is further noted that various figures (including component diagrams) shown and discussed herein are for illustrative purpose only, and are not drawn to scale.

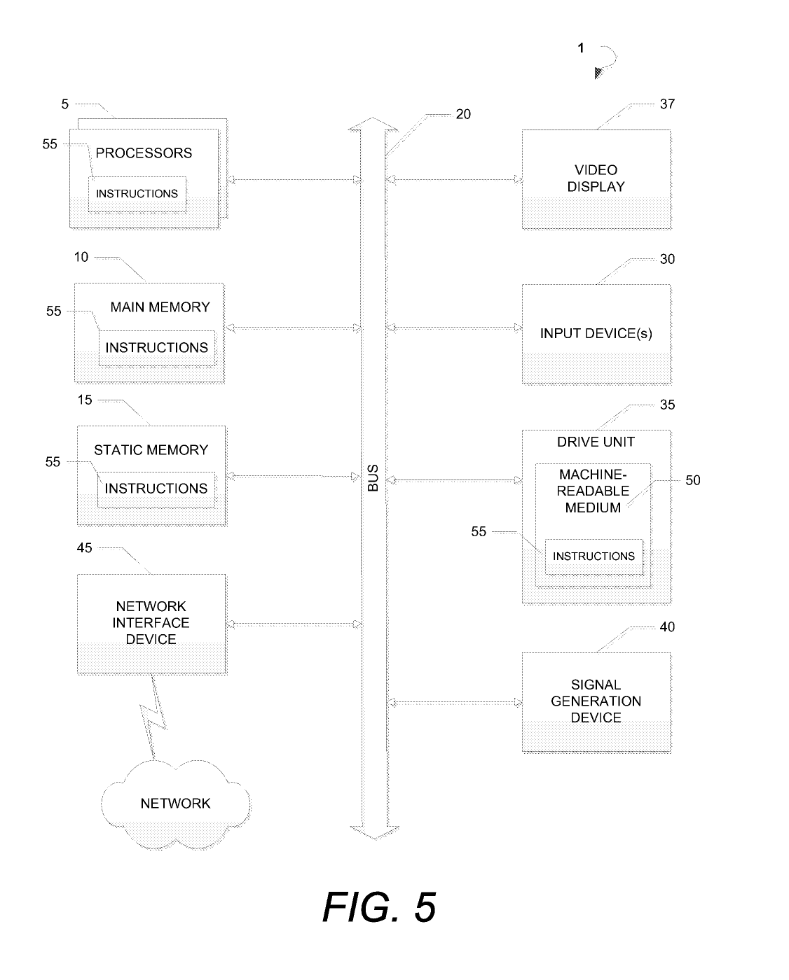

FIG. 5 is a diagrammatic representation of an example machine in the form of a computer system 1, within which a set of instructions for causing the machine to perform any one or more of the methodologies discussed herein may be executed. In various example embodiments, the machine operates as a standalone device or may be connected (e.g., networked) to other machines. In a networked deployment, the machine may operate in the capacity of a server or a client machine in a server-client network environment, or as a peer machine in a peer-to-peer (or distributed) network environment. The machine may be a personal computer (PC), a tablet PC, a set-top box (STB), a personal digital assistant (PDA), a cellular telephone, a portable music player (e.g., a portable hard drive audio device such as an Moving Picture Experts Group Audio Layer 3 (MP3) player), a web appliance, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 1 includes a processor or multiple processors 5 (e.g., a central processing unit (CPU), a graphics processing unit (GPU), or both), and a main memory 10 and static memory 15, which communicate with each other via a bus 20. The computer system 1 may further include a video display 37 (e.g., a liquid crystal display (LCD)). The computer system 1 may also include an alpha-numeric input device(s) 30 (e.g., a keyboard), a cursor control device (e.g., a mouse), a voice recognition or biometric verification unit (not shown), a drive unit 35 (also referred to as disk drive unit), a signal generation device 40 (e.g., a speaker), and a network interface device 45. The computer system 1 may further include a data encryption module (not shown) to encrypt data.

The drive unit 35 includes a computer or machine-readable medium 50 on which is stored one or more sets of instructions and data structures (e.g., instructions 55) embodying or utilizing any one or more of the methodologies or functions described herein. The instructions 55 may also reside, completely or at least partially, within the main memory 10 and/or within the processors 5 during execution thereof by the computer system 1. The main memory 10 and the processors 5 may also constitute machine-readable media.

The instructions 55 may further be transmitted or received over a network via the network interface device 45 utilizing any one of a number of well-known transfer protocols (e.g., Hyper Text Transfer Protocol (HTTP)). While the machine-readable medium 50 is shown in an example embodiment to be a single medium, the term “computer-readable medium” should be taken to include a single medium or multiple media (e.g., a centralized or distributed database and/or associated caches and servers) that store the one or more sets of instructions. The term “computer-readable medium” shall also be taken to include any medium that is capable of storing, encoding, or carrying a set of instructions for execution by the machine and that causes the machine to perform any one or more of the methodologies of the present application, or that is capable of storing, encoding, or carrying data structures utilized by or associated with such a set of instructions. The term “computer-readable medium” shall accordingly be taken to include, but not be limited to, solid-state memories, optical and magnetic media, and carrier wave signals. Such media may also include, without limitation, hard disks, floppy disks, flash memory cards, digital video disks, random access memory (RAM), read only memory (ROM), and the like. The example embodiments described herein may be implemented in an operating environment comprising software installed on a computer, in hardware, or in a combination of software and hardware.

One skilled in the art will recognize that the Internet service may be configured to provide Internet access to one or more computing devices that are coupled to the Internet service, and that the computing devices may include one or more processors, buses, memory devices, display devices, input/output devices, and the like. Furthermore, those skilled in the art may appreciate that the Internet service may be coupled to one or more databases, repositories, servers, and the like, which may be utilized in order to implement any of the embodiments of the disclosure as described herein.

The corresponding structures, materials, acts, and equivalents of all means or step plus function elements in the claims below are intended to include any structure, material, or act for performing the function in combination with other claimed elements as specifically claimed. The description of the present technology has been presented for purposes of illustration and description, but is not intended to be exhaustive or limited to the present technology in the form disclosed. Many modifications and variations will be apparent to those of ordinary skill in the art without departing from the scope and spirit of the present technology. Exemplary embodiments were chosen and described in order to best explain the principles of the present technology and its practical application, and to enable others of ordinary skill in the art to understand the present technology for various embodiments with various modifications as are suited to the particular use contemplated. Aspects of the present technology are described above with reference to flowchart illustrations and/or block diagrams of methods, apparatus (systems) and computer program products according to embodiments of the present technology. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods and computer program products according to various embodiments of the present technology. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

While specific embodiments of, and examples for, the system are described above for illustrative purposes, various equivalent modifications are possible within the scope of the system, as those skilled in the relevant art will recognize. For example, while processes or steps are presented in a given order, alternative embodiments may perform routines having steps in a different order, and some processes or steps may be deleted, moved, added, subdivided, combined, and/or modified to provide alternative or sub-combinations. Each of these processes or steps may be implemented in a variety of different ways. Also, while processes or steps are at times shown as being performed in series, these processes or steps may instead be performed in parallel, or may be performed at different times.

While various embodiments have been described above, it should be understood that they have been presented by way of example only, and not limitation. The descriptions are not intended to limit the scope of the invention to the particular forms set forth herein. To the contrary, the present descriptions are intended to cover such alternatives, modifications, and equivalents as may be included within the spirit and scope of the invention as defined by the appended claims and otherwise appreciated by one of ordinary skill in the art. Thus, the breadth and scope of a preferred embodiment should not be limited by any of the above-described exemplary embodiments.

What is claimed is:

1. A method, comprising:
receiving from a captive portal sign-on user interface, a request for network access from a user, the request comprising authentication credentials;
redirecting the user to an identity server when the user has been authenticated for network access using the authentication credentials, wherein the redirecting comprises automatically providing the identity server with the authentication credentials;
generating a single sign (SSO) token by the identity server, the SSO token allowing the user to access enterprise applications; and
providing the SSO token to the user.

2. The method of claim 1, wherein the user signs on to the enterprise applications using the SSO token without entering authentication credentials when requesting the SSO token or accessing the enterprise applications.

3. The method of claim 1, wherein providing the identity server with the authentication credentials comprises automatically filling the authentication credentials into an identity provider login page that is generated by the identity server using a script.

4. The method of claim 1, further comprising receiving a request for network access from the user; and causing the captive portal sign-on user interface to be displayed to the user.

5. The method of claim 1, further comprising applying one or more user policies that determine which enterprise applications are appropriate for the user when the user requests access to one of the enterprise applications using the SSO token.

6. A system, comprising:
a captive portal configured to:
receive from a captive portal sign-on user interface, a request for network access from a user, the request comprising authentication credentials;
authenticate the user for network access;
redirect the user to an identity server to obtain a single sign on (SSO) token for the user, wherein the redirect includes submitting to the identity server a request for the SSO token, the request comprising the authentication credentials; and
the identity server being configured to:
authenticate the user using the authentication credentials;
generate an SSO token for the user, wherein the SSO token allows the user to access enterprise applications; and
provide the SSO token to the user.

7. The system of claim 6, wherein the captive portal causes to be displayed a captive portal sign-on user interface to the user for display.

8. The system of claim 6, further comprising an enterprise server that allows the user to sign on to the enterprise applications without entering authentication credentials when requesting the SSO token or accessing the enterprise applications.

9. The system of claim 8, wherein the captive portal submits the request for the SSO token by generating a script that includes a request for an identity provider login page and the authentication credentials, the script being configured to automatically submit the authentication credentials into the identity provider login page.

10. The system of claim 6, wherein the captive portal receives a request for network access from a user; and returns the captive portal sign-on user interface to the user.

11. The system of claim 6, wherein the identity server applies one or more user policies to specify how the user can access the one or more enterprise applications.

12. A method, comprising: in response to authenticating a user for network access through a captive portal interface, generating a single sign on (SSO) login object that allows the user to access one or more enterprise applications; and providing the SSO login object to the user.

13. The method of claim 12, wherein the SSO login object is an SSO token that is provided to a web browser of a client of the user, the SSO token being a cookie.

14. The method of claim 12, wherein the user signs on to the enterprise applications using the SSO login object without entering authentication credentials when requesting the SSO login object or accessing the enterprise applications.

15. The method of claim 12, further comprising receiving a request for network access from a user; and returning a captive portal sign-on user interface to the user.

16. The method of claim 12, wherein the SSO login object comprises any of an SSO token or a secure certificate.

17. The method of claim 12, wherein generating the SSO login object comprises:
receiving authentication credentials during network authentication; and
providing the authentication credentials to an identity provider login page without requiring the user to re-enter the authentication credentials into the identity provider login page.

18. The method of claim 17, wherein providing the authentication credentials includes generating a script that requests the identity provider login page and automatically submits the authentication credentials to the identity provider login page.

19. The method of claim 12, further comprising locating user policies for each of the one or more enterprise applications; and applying the user policies when the SSO token is provided to a service provider of the one or more enterprise applications, wherein the user policies specify how the user can access or utilize the one or more enterprise applications.

20. The method of claim 19, wherein the service provider redirects a request for the one or more enterprise applications to an identity server that locates and applies the user policies.
